(19) United States
(12) Patent Application Publication
(10) Pub. No.: US 2004/0126311 A1
(43) Pub. Date: Jul. 1, 2004

(54) Process for removing organic impurities from sulfuric acid with liquid or supercritical carbon dioxide

(76) Inventors: Andrew Sanderson, North Ogden, UT (US); Sharon Dressen, Ogden, UT (US)

Correspondence Address: TRASK BRITT, P.O. BOX 2550, SALT LAKE CITY, UT, 84110, US

(21) Appl. No.: 10/335,150

(22) Filed: Dec. 31, 2002

(51) Int. Cl. C01B 17/90

(52) U.S. Cl. 423/531; 423/394.2

(57) ABSTRACT

A process for the removal of organic impurities from sulfuric acid utilizing either liquid or super critical carbon dioxide is provided. The process comprises providing a solution of sulfuric acid contaminated with at least one organic compound and subjecting the solution to countercurrent extraction with one of supercritical carbon dioxide and liquid carbon dioxide. Processes for removing organic contaminants from a waste stream generated in the manufacture of trinitrotoluene are also provided.

### BACKGROUND OF THE INVENTION

1. Field of the Invention

The present invention relates generally to processes for removing impurities from acids. More specifically, the present invention relates to a process for removing organic impurities from sulfuric acid utilizing either liquid or supercritical carbon dioxide.

2. State of the Art

Spent acids from industrial processes, such as nitration, typically contain some dissolved organic compounds. For instance, a conventional manufacturing process for trinitrotoluene (TNT), which involves the counter-current nitration of toluene or orthonitrotoluene (ONT) in the presence of mixed acids (sulfuric acid and nitric acid), yields a primary waste stream comprised of spent sulfuric acid, spent nitric acid, a small amount of TNT, isomers of dinitrotoluene (DNT) and water. In many applications, it is desirable to recover and concentrate the spent acids for reuse. If the organic compounds are permitted to remain in the spent acids through subsequent acid concentration processes, such compounds may either build up over time, significantly decreasing the quality of the acid, or plate out on the heat exchangers or other parts of the acid concentration system. Both such results are undesirable. Recovery of the spent acids from the waste stream, accordingly, must involve removal of the organic compounds therefrom before the acids may be recycled. Removal of organic compounds from spent acids is necessary for the proper disposal thereof as well.

Various processes have been developed for separating acids from organic compounds. For example, U.S. Pat. No. 5,001,286 describes a process for separating sulfuric acid and nitric acid from dinitrotoluenes obtained during the dinitration of toluene with mixed acids. First, a phase consisting essentially of dinitrotoluenes is separated from the majority of mixed acids remaining after nitration. This separated phase, however, may still be contaminated with up to 6 wt. % sulfuric acid and up to 5 wt. % nitric acid. To separate such acids from the dinitrotoluenes, the phase is mixed with up to 10 wt. % water (based upon the quantity of dinitrotoluenes). This creates an aqueous phase which contains the remaining sulfuric acid and nitric acid. This aqueous phase is allowed to separate and is removed yielding uncontaminated dinitrotoluenes.

While useful for extracting essentially pure dinitrotoluenes, the separated acid-containing phase may still contain organic compounds which must be removed before the acids may be recycled or disposed of properly.

A number of processes have been developed for removing organic compounds from contaminated sulfuric acid. For instance, in U.S. Pat. No. 5,501,847, a process is described for removing hydrocarbon substances from an impure sulfuric acid solution. The process comprises impregnating an impure sulfuric acid solution into an organic or inorganic porous support (e.g., silica) and calcining the impregnated support in an oxygen-containing gas to desorb the sulfuric acid while retaining the hydrocarbons in the silica.

Further processes for removal of organic compounds from contaminated sulfuric acid have also been developed. For example, in one process, the organic compounds are essentially burned off by heating the contaminated sulfuric acid to very high temperatures. This process is known as pyrolysis. In other processes, known as decomposition processes, oxidants or reducing agents may be added to the contaminated sulfuric acid to convert the organic compounds to gaseous products. Pyrolysis and decomposition processes are undesirable in that they involve dangerously high temperatures and/or the addition of compounds which pose potential occupational safety and environmental concerns.

In still further processes for the removal of organic compounds from contaminated sulfuric acid, non-polar, low polarity, volatile organic solvents having very low solubility in sulfuric acid (e.g., toluene or butane), are used to extract organic compounds from contaminated sulfuric acid. In such extraction processes, the organic compounds are extracted into the solvent which is then separated from the sulfuric acid and incinerated or evaporated to recover the impurities. Any solvent remaining in the sulfuric acid is evaporated during acid concentration processes. This approach is acceptable only if the partition coefficient (i.e., the distribution coefficient) is favorable and all the solvent can be removed from the acid. Further, such volatile organic solvents are highly flammable and pose environmental safety concerns.

U.S. Pat. No. 5,953,679 describes a method for disposing of military high explosives wherein TNT is extracted from a high explosive by contacting the high explosive with supercritical carbon dioxide at a temperature above the melting point of TNT. The disclosed method, however, does not address the extraction of TNT from other than high explosives, nor does it address the use of supercritical fluids to extract organic compounds other than TNT.

While the above-listed processes for removal of organic compounds from sulfuric acid are acceptable in certain circumstances, the inventors have recognized that a process for purifying sulfuric acid which does not involve dangerously high temperatures or addition of additional hazardous solvents or non-recoverable reagents would be advantageous.

### BRIEF SUMMARY OF THE INVENTION

The present invention relates to a process for the removal of organic impurities from sulfuric acid utilizing either liquid or supercritical carbon dioxide. The process comprises providing a solution of sulfuric acid contaminated with at least one organic compound and subjecting the solution to a countercurrent extraction with either supercritical carbon dioxide or liquid carbon dioxide. Using a general rule of thumb, if the at least one organic compound is trinitrotoluene, at least four times more supercritical or liquid carbon dioxide (by weight) is to be added to the countercurrent extractor than contaminated sulfuric acid. It will be understood and appreciated by those of ordinary skill in the art, however, that the same end may be achieved by conducting approximately four separations at an approximately equal concentration of carbon dioxide and sulfuric acid. The important factor is achieving approximately equal separation between the two phases, not how that end is achieved.

The present invention further relates to a process for removing organic contaminants from a waste stream generated in the manufacture of trinitrotoluene. The process comprises mixing toluene, dinitrotoluene, or orthonitrotoluene with mixed acids to generate a product stream and a waste stream. The waste stream comprises nitric acid, sulfuric acid and at least one organic contaminant. Subsequently, the waste stream is boiled to remove the nitric acid therefrom, producing a residual stream comprised of sulfuric acid and the at least one organic contaminant. The residual stream is then subjected to countercurrent extraction with either supercritical carbon dioxide or liquid carbon dioxide to remove the at least one organic contaminant therefrom.

Additionally, the present invention relates to a further process for removing organic contaminants from a waste stream generated in the manufacture of trinitrotoluene. The process comprises mixing toluene or orthonitrotoluene with mixed acids to generate a product stream and a waste stream. The waste stream comprises nitric acid, sulfuric acid and at least one organic contaminant. Subsequently, the waste stream is subjected to countercurrent extraction with either supercritical carbon dioxide or liquid carbon dioxide to remove the at least one organic contaminant therefrom and create a residual acid stream. The residual acid stream is then boiled to remove the nitric acid therefrom.

Additional aspects of the invention, together with the advantages and novel features appurtenant thereto, will be set forth in the description which follows and will also become readily apparent to those of ordinary skill in the art upon examination of the following and from the practice of the invention.

### BRIEF DESCRIPTION OF THE DRAWINGS

In the accompanying drawings which form a part of the specification and are to be read in conjunction therewith:

FIG. 1 is schematic illustration of an exemplary process of the present invention for removing organic impurities from spent sulfuric acid generated during the manufacture of trinitrotoluene, the organic impurities being removed subsequent to removal of nitric acid therefrom;

FIG. 2 is a schematic illustration of a further exemplary process of the present invention for removing organic impurities from spent sulfuric acid generated during the manufacture of trinitrotoluene, the organic impurities being removed prior to stripping off and concentrating the nitric acid; and

FIG. 3 is a schematic illustration of an exemplary countercurrent extraction process which may be used in the processes of the present invention.

### DETAILED DESCRIPTION OF THE INVENTION

The present invention is directed to a process for removing organic impurities from sulfuric acid utilizing either liquid or supercritical carbon dioxide. The particular embodiments described herein are intended in all respects to be illustrative rather than restrictive. Other and further embodiments will become apparent to those of ordinary skill in the art to which the present invention pertains without departing from its scope.

The present invention provides a process for the removal of organic impurities from sulfuric acid utilizing carbon dioxide in either its liquid or supercritical form. While the description and examples herein focus on removal of organic impurities from spent sulfuric acid generated during the manufacture of trinitrotoluene (TNT), it will be understood and appreciated by those of ordinary skill in the art that the processes herein described may be used to remove organic impurities from sulfuric acid regardless of the source of the impurities.

A supercritical fluid is a compound that shares properties of both liquids and gases and is obtained under conditions exceeding the critical temperature and critical pressure of the material. For carbon dioxide (CO₂), the critical temperature and pressure are approximately 31° C. and approximately 1073 pounds per square inch (psi), respectively. Supercritical CO₂ is a good solvent for many organic compounds and is virtually inert, non-toxic and non-flammable. Accordingly, its use promotes occupational and environmental safety. Additionally, supercritical CO₂ is a low cost alternative to other methods for extraction of organic compounds as CO₂ is widely available as a by product of ethanol fermentation, is relatively inexpensive and requires no waste solvent disposal cost. After use, the only waste stream generated is comprised of the contaminants that have been removed.

Supercritical CO₂ is an attractive alternative to organic solvents because it is abundant, inexpensive, contaminant-free, and environmentally friendly. Supercritical CO₂ acts like an organic solvent but possesses higher diffusivity, lower viscosity and lower surface tension. Its polarity, and thus its effectiveness as a solvent, may be adjusted by varying the temperature and pressure or by adding co-solvents.

In the processes of the present invention, sulfuric acid contaminated with organic compounds is exposed to carbon dioxide, in either its liquid or supercritical form, in a countercurrent extraction process. The contaminated sulfuric acid flows into a countercurrent extractor. Carbon dioxide (either liquid or supercritical) also flows into the countercurrent extractor such that the direction of flow is opposite that of the contaminated sulfuric acid. Due to the high solubility of the organic compounds in the carbon dioxide relative to the solubility of the sulfuric acid therein, the organic compounds are dissolved in the carbon dioxide creating a waste solution comprised of a mixture of carbon dioxide and organic compounds. The sulfuric acid which remains is essentially free of organic contaminants.

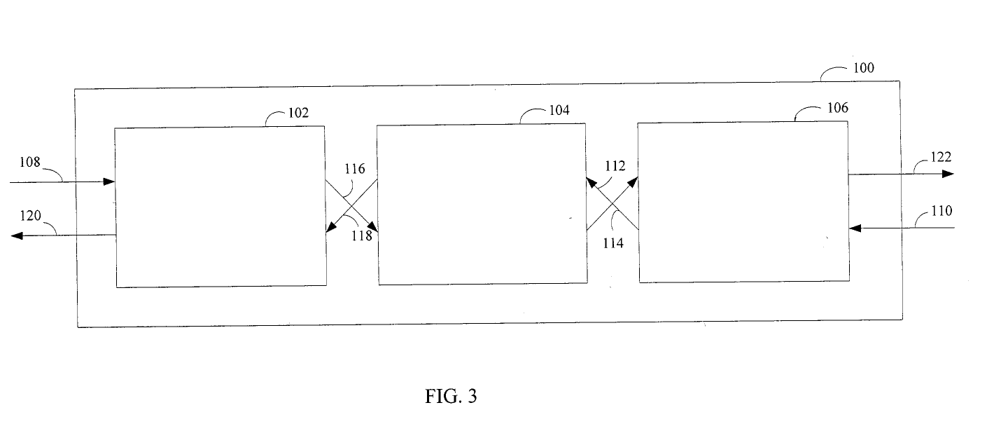

The basic principle of countercurrent extraction is illustrated in FIG. 3. The countercurrent extractor 100 includes a plurality of extraction chambers 102, 104, 106 therein. While in the exemplary countercurrent extractor of FIG. 3, three extraction chambers 102, 104, 106 are shown, it will be understood and appreciated by those of ordinary skill in the art that the countercurrent extractor 100 may include any desired number of extraction chambers. For instance, the countercurrent extractor 100 may be a single column extractor or the like. All such variations are contemplated to be within the scope hereof.

Carbon dioxide (either liquid or supercritical) is fed into one end of the countercurrent extractor 100 and, accordingly, into one of the extraction chambers 102 as indicated at 108. Contaminated sulfuric acid 110 is fed into the opposing end of the countercurrent extractor 100 and into another of the extraction chambers 106 as indicated at 110. The carbon dioxide and sulfuric acid then flow in opposing directions between the extraction chambers 102, 104, 106 (the flow streams being shown as reference numerals 112 through 118). As the illustrated process is a continuous process, each extraction chamber 102, 104, 106 contains a certain amount of each of carbon dioxide, sulfuric acid and contaminants. The distribution gradient, however, favors dissolution of the contaminants in the carbon dioxide in each chamber as the chamber having the greatest amount of carbon dioxide therein (i.e., the chamber into which the pure carbon dioxide is fed), also has the least amount of contaminants, as most of the contaminants will have been dissolved into the carbon dioxide prior to reaching the end of the countercurrent extractor 100 having the greatest amount of carbon dioxide. Accordingly, a stream of sulfuric acid which is substantially free of contaminants 120 and a stream of carbon dioxide having contaminants dissolved therein 122 are expelled from the countercurrent extractor 100.

### EXAMPLES

### Example I

### Removal of Organic Impurities from Spent Sulfuric Acid Generated During the Manufacture of Trinitrotoluene (TNT), Organic Impurities Being Removed Subsequent to Removal of Nitric Acid Therefrom

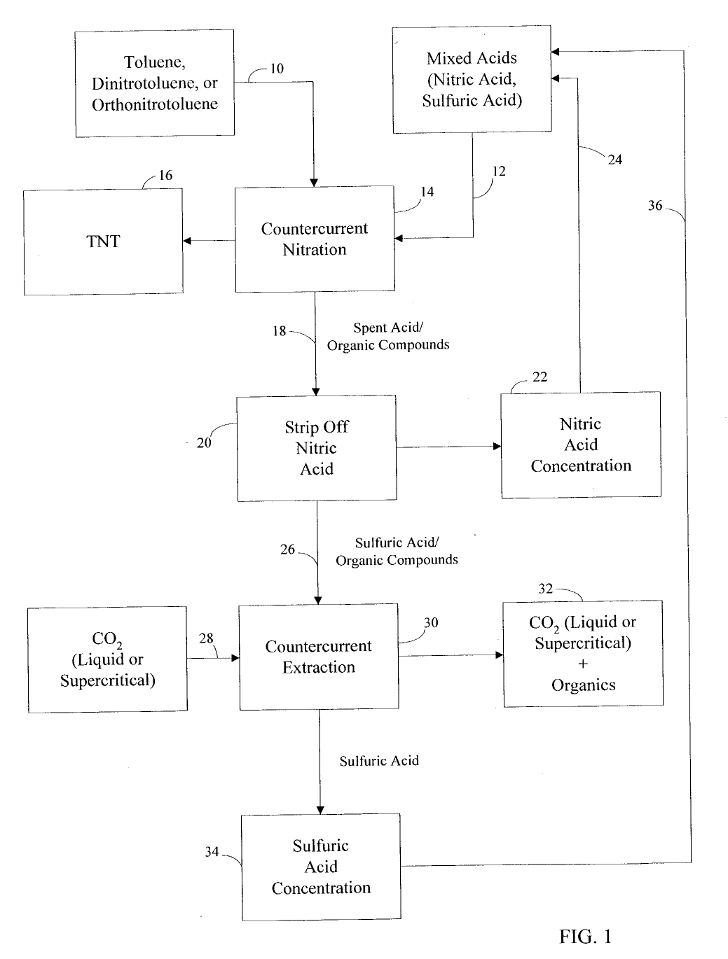

FIG. 1 illustrates an exemplary process for the manufacture of TNT and subsequent removal of organic impurities from the spent sulfuric acid generated during the manufacturing process. Toluene, dinitrotoluene (DNT), or orthonitrotoluene (ONT) was fed into a first end of a countercurrent extractor 10 and mixed acids (i.e., sulfuric acid and nitric acid) were fed into an opposing second end of the countercurrent extractor 12 such that the direction of flow was opposite that of the toluene, DNT, or ONT. A countercurrent nitration was commenced 14 generating a product stream comprised of TNT 16 and a waste stream comprised of spent acids (sulfuric and nitric acids) and organics compounds 18. The organic compounds were comprised primarily of a small amount of TNT and isomers of DNT.

Subsequently, the nitric acid was boiled off of the waste stream 20, concentrated 22 and recycled 24 for use in subsequent mixed acid nitrations. The remaining stream was thus comprised of sulfuric acid contaminated with organic compounds. The contaminated sulfuric acid was subsequently fed into one end of a countercurrent extractor 26 and carbon dioxide (either liquid or supercritical) was fed into the other end of the countercurrent extractor 28 such that the direction of flow was opposite that of the contaminated sulfuric acid. A countercurrent extraction was commenced 30. Due to the high solubility of the organic compounds in the carbon dioxide relative to the solubility of the sulfuric acid therein, the organic compounds were dissolved in the carbon dioxide creating a waste solution comprised of a mixture of carbon dioxide and organic compounds 32. The sulfuric acid which remained was essentially free of organic contaminants.

The contaminant-free sulfuric acid was then concentrated 34 and recycled 36 for use in subsequent nitration processes.

### Example II

### Removal of Organic Impurities from Spent Sulfuric Acid Generated During the Manufacture of Trinitrotoluene (TNT), Organic Impurities Being Removed Prior to Stripping Off and Concentrating the Nitric Acid

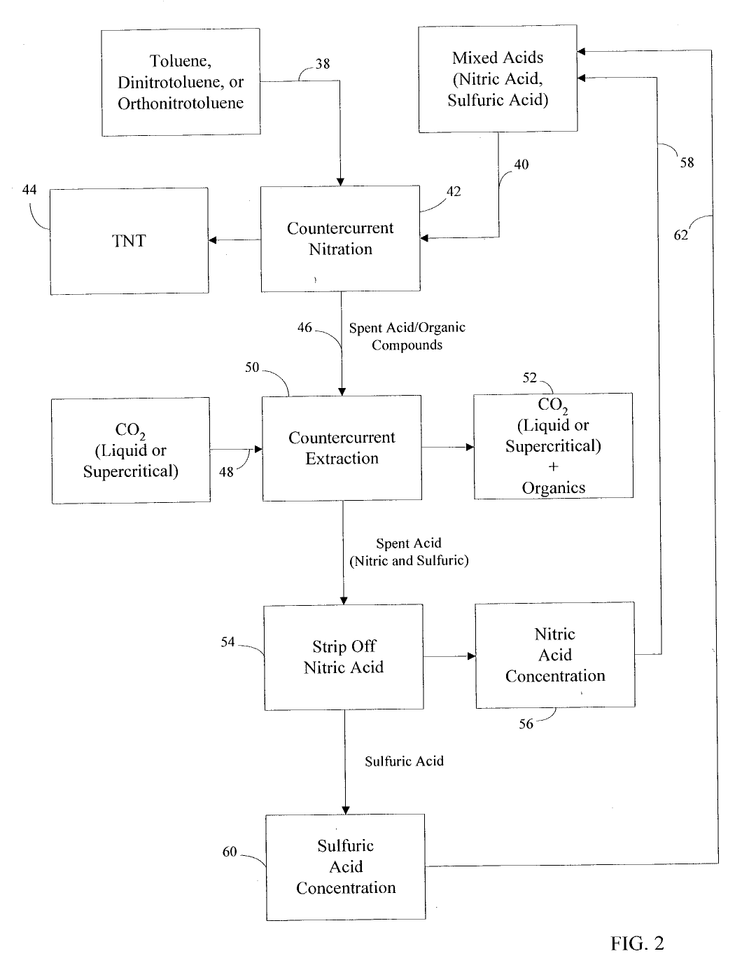

FIG. 2 illustrates a further exemplary process for the manufacture of TNT and subsequent removal of organic impurities from the spent sulfuric acid generated during the manufacturing process. The process of FIG. 2 is similar to the process illustrated in FIG. 1 except the organic impurities were removed from the waste stream prior to boiling off the nitric acid.

Again, toluene, DNT, or ONT was fed into a first end of a countercurrent extractor 38 and mixed acids (i.e., sulfuric acid and nitric acid) were fed into an opposing second end of the countercurrent extractor 40 such that the direction of flow was opposite that of the toluene, DNT, or ONT. A countercurrent extraction was commenced 42 generating a product stream comprised of TNT 44 and a waste stream comprised of spent acids (sulfuric and nitric acids) and organics compounds. The organic compounds were comprised primarily of a small amount of TNT and isomers of dinitrotoluene (DNT).

The waste stream was subsequently fed into one end of a countercurrent extractor 46 and carbon dioxide (either liquid or supercritical) was fed into the other end of the countercurrent extractor 48 in the opposite direction. A countercurrent extraction was commenced 50. Due to the high solubility of the organic compounds in the carbon dioxide relative to the solubility of the sulfuric acid therein, the organic compounds were dissolved in the carbon dioxide creating a waste stream 52 comprised of a mixture of carbon dioxide and organic compounds. The mixed acids which remained were essentially free of organic contaminants.

Subsequently, the nitric acid was boiled off of the mixed acid stream 54, concentrated 56 and recycled 58 for use in subsequent mixed acid nitrations. The contaminant-free sulfuric acid was also concentrated 60 and recycled 62 for subsequent use as well.

### Example III

Determination of Partition Coefficient for Sulfuric Acid Contaminated with TNT and isomers of DNT

The amount of carbon dioxide which may be supplied to the countercurrent extractor to extract substantially all of the organic contaminants from the sulfuric acid therein under a given set of reaction conditions was determined based upon the partition coefficient of the reaction. If a substance is dissolved in two immiscible liquids standing in contact with one another, the substance will partition or distribute itself between the two liquids in a constant ratio known as the partition coefficient (K). The value of this constant is dependent upon the temperature and on the identity of the solute and the solvents. Thus, the preferential solubility of a contaminant in the extraction solvent CO₂ may be expressed as follows:

K=[wt. fraction of contaminant in CO₂]/[wt. fraction of contaminant in sulfuric acid].

To determine the partition coefficient for sulfuric acid contaminated with TNT in the extraction solvent CO₂ (i.e., for the reaction of Example I), a Parr bomb was first loaded with contaminated sulfuric acid having approximately 1.56 wt % TNT and then with dry ice. Once the internal Parr bomb temperature reached 35° C., agitation thereof was commenced.

Pairs of samples were taken at various temperatures under supercritical conditions (see Table I). A final pair of samples was taken at 3° C. (non-supercritical conditions) after immersing the Parr bomb in an ice bath. The first sample of each pair consisted of material trapped in the dip tube during agitation. The second sample of each pair was presumed to be a better representative of the contents under a given set of conditions. Only the second sample in each pair was considered for analysis.

TABLE I
Sampling Conditions

| Sample | Temperature | | |
|---|---|---|---|
| Number | (° C.) | Pressure (psig) | CO₂ phase |
| A-01 | 75 | 1830 | Supercritical |
| A-02 | 75 | 1820 | Supercritical |
| B-01 | 65 | 1640 | Supercritical |
| B-02 | 65 | 1600 | Supercritical |
| C-01 | 55 | 1480 | Supercritical |
| C-02 | 55 | 1460 | Supercritical |
| D-01 | 45 | 1320 | Supercritical |
| D-02 | 45 | 1310 | Supercritical |
| E-01 | 3 | 520 | Liquid |
| E-02 | 3 | 510 | Liquid |

The Parr bomb contents were constantly agitated except for the five minutes before and during each sampling. As seen in Table I, each sampling resulted in an approximately 10 psig drop in the main vessel. Samples were typically collected in the form of a foam and became liquid as the CO₂ escaped into the atmosphere.

Samples were diluted with DMSO and ¹H-NMR analysis was performed. The weight fractions of TNT in CO₂ and in the acid were calculated from the NMR results. Contributions due to water and acid were taken into account. The original spent acid composition was taken to be 85 mol % sulfuric acid and 15 mol % water, with a density of 1.7 g/mL. Corrections for the loss of material with each sampling were 4 mL for the acid solution and 3.75 g for CO₂.

The partition coefficient was determined to be between 0.23 and 0.26 over the temperature range studied (see Table II). (Variations in the calculated partition coefficient may be attributed to the differences in CO₂ initially added to the Parr bomb.) Using the general rule of thumb, a partition coefficient of 0.25 suggests that at least four times more CO₂ than acid (by weight) is necessary, under the specified reaction conditions, to extract TNT from sulfuric in a countercurrent extractor. It will be understood and appreciated by those of ordinary skill in the art, however, that the same end may be achieved by conducting approximately four times as many separations at an approximately equal concentration of carbon dioxide and sulfuric acid. The important factor is achieving approximately equal separation between the two phases, not how that end is achieved.

To reduce the TNT content to the ppm (parts per million) level, calculations indicate that a countercurrent extractor would require a minimum of 25 stages at 3° C., 25 stages at 45°, or 32 stages at 75° C.

TABLE II
Calculated Partition Coefficient

| Sample | | TNT in CO₂ | TNT in acid layer |
|---|---|---|---|
| Number | K | wt fraction | wt fraction |
| Reference | 0 | 0 | 0.015622 |
| E-02 | 0.245 | 0.002829 | 0.011527 |
| D-02 | 0.262 | 0.003028 | 0.11558 |
| A-02 | 0.237 | 0.002920 | 0.012307 |

The above example illustrates that supercritical CO₂ is an adequate solvent for dissolved TNT in sulfuric acid solution. The primary advantages to choosing CO₂ are its ease of operation, low cost and environmentally friendly clean-up. The extraction of TNT from contaminated sulfuric acid can be accomplished with supercritical CO₂. The extraction of TNT at 3° C. and 520 psig (non-supercritical conditions) indicates that liquid CO₂ may also be a viable extraction liquid.

The present invention has been described in relation to particular embodiments which are intended in all respects to be illustrative rather than restrictive. Other and further embodiments will become apparent to those skilled in the art to which the present invention pertains without departing from its scope. From the foregoing, it will be seen that this invention is one well adapted to attain all the ends and aspects hereinabove set forth, together with other advantages which are obvious and which are inherent to the compositions. It will be understood and appreciated that certain features and subcombinations are of utility and may be employed without reference to other features and subcombinations. This is contemplated by and is within the scope of the claims. Since many possible embodiments may be made of the invention without departing from the scope hereof, it is to be understood that all matter herein set forth is to be interpreted as illustrative and not in a limiting sense.

What is claimed is:

1. A process for removing organic impurities from sulfuric acid, comprising:
providing a solution of sulfuric acid contaminated with at least one organic compound; and
subjecting the solution to a countercurrent extraction with supercritical carbon dioxide.

2. The process of claim 1, wherein providing the solution of sulfuric acid contaminated with at least one organic compound comprises providing a solution of sulfuric acid contaminated with trinitrotoluene.

3. The process of claim 2, wherein subjecting the solution to a countercurrent extraction with supercritical carbon dioxide comprises:
adding a volume of the solution to a countercurrent extractor;
adding a volume of supercritical carbon dioxide to the countercurrent extractor; and
conducting the countercurrent extraction in the countercurrent extractor.

4. A process for removing organic impurities from sulfuric acid, comprising:
providing a solution of sulfuric acid contaminated with at least one organic compound; and
subjecting the solution to a countercurrent extraction with liquid carbon dioxide.

5. The process of claim 4, wherein providing the solution of sulfuric acid contaminated with at least one organic compound comprises providing a solution of sulfuric acid contaminated with trinitrotoluene.

6. The process of claim 5, wherein subjecting the solution to a countercurrent extraction with liquid carbon dioxide comprises:
adding a volume of the solution to a countercurrent extractor;
adding a volume of liquid carbon dioxide to the countercurrent extractor; and
conducting the countercurrent extraction in the countercurrent extractor.

7. A process for purifying contaminated sulfuric acid, comprising:
providing a solution of sulfuric acid contaminated with at least one organic compound; and
removing the at least one organic compound from the solution by subjecting the solution to a countercurrent extraction with one of supercritical carbon dioxide and liquid carbon dioxide.

8. The process of claim 7, wherein providing the solution of sulfuric acid contaminated with at least one organic compound comprises providing a solution of sulfuric acid contaminated with trinitrotoluene.

9. The process of claim 8, wherein removing the at least one organic compound from the solution by subjecting the solution to a countercurrent extraction comprises:
adding a volume of the solution to a countercurrent extractor;
adding a volume of supercritical carbon dioxide to the countercurrent extractor; and
conducting the countercurrent extraction in the countercurrent extractor.

10. The process of claim 8, wherein removing the at least one organic compound from the solution by subjecting the solution to a countercurrent extraction comprises:
adding a volume of the solution to a countercurrent extractor;
adding a volume of liquid carbon dioxide to the countercurrent extractor; and
conducting the countercurrent extraction in the countercurrent extractor.

11. A process for removing organic contaminants from a waste stream generated in the manufacture of trinitrotoluene, comprising:
mixing at least one of toluene and orthonitrotoluene with mixed acids to generate a product stream and a waste stream, wherein the waste stream comprises nitric acid, sulfuric acid and at least one organic contaminant;
boiling the waste stream to remove the nitric acid therefrom producing a residual stream comprised of sulfuric acid and the at least one organic contaminant; and
subjecting the residual stream to countercurrent extraction with at least one of supercritical carbon dioxide and liquid carbon dioxide to remove the at least one organic contaminant therefrom.

12. The process of claim 11, wherein mixing at least one of toluene and orthonitrotoluene with mixed acids to generate the product stream and the waste stream comprises mixing at least one of toluene and orthonitrotoluene with mixed acids to generate a waste stream comprising sulfuric acid contaminated with trinitrotoluene.

13. The process of claim 12, wherein subjecting the residual stream to countercurrent extraction to remove the at least one organic contaminant therefrom comprises:
adding a volume of the solution to a countercurrent extractor;
adding a volume of supercritical carbon dioxide to the countercurrent extractor; and
conducting the countercurrent extraction in the countercurrent extractor.

14. The process of claim 12, wherein subjecting the residual stream to countercurrent extraction to remove the at least one organic contaminant therefrom comprises:
adding a volume of the solution to a countercurrent extractor;
adding a volume of liquid carbon dioxide to the countercurrent extractor; and
conducting a countercurrent extraction in the countercurrent extractor.

15. A process for removing organic contaminants from a waste stream generated in the manufacture of trinitrotoluene, comprising:
mixing at least one of toluene and orthonitrotoluene with mixed acids to generate a product stream and a waste stream, wherein the waste stream comprises nitric acid, sulfuric acid and at least one organic contaminant;
subjecting the waste stream to countercurrent extraction with at least one of supercritical carbon dioxide and liquid carbon dioxide to remove the at least one organic contaminant therefrom and create a residual acid stream; and
boiling the residual acid stream to remove the nitric acid therefrom.

16. The process of claim 15, wherein mixing at least one of toluene and orthonitrotoluene with mixed acids to generate the product stream and the waste stream comprises mixing at least one of toluene and orthonitrotoluene with mixed acids to generate a waste stream comprising sulfuric acid contaminated with trinitrotoluene.

17. The process of claim 16, wherein subjecting the waste stream to countercurrent extraction to remove the at least one organic contaminant therefrom and create a residual acid stream comprises:
adding a volume of the solution to a countercurrent extractor;
adding a volume of supercritical carbon dioxide to the countercurrent extractor; and
conducting the countercurrent extraction in the countercurrent extractor.

18. The process of claim 16, wherein subjecting the waste stream to countercurrent extraction to remove the at least one organic contaminant therefrom and create a residual acid stream comprises:
adding a volume of the solution to a countercurrent extractor;
adding a volume of liquid carbon dioxide to the countercurrent extractor; and
conducting the countercurrent extraction in the countercurrent extractor.
